(19) United States
(12) Patent Application Publication
(10) Pub. No.: US 2010/0219678 A1
(43) Pub. Date: Sep. 2, 2010

(54) ELECTROHYDRAULIC BRAKE UNIT FOR A LAND VEHICLE

(76) Inventor: Boris Koeth, Weitersburg (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 12/680,800

(22) PCT Filed: Sep. 29, 2008
(86) PCT No.: PCT/EP2008/008274

§ 371 Date: Apr. 15, 2010

(30) Foreign Application Priority Data
Oct. 2, 2007 (DE) 10 2007 047 208.2

(51) Int. Cl. B60T 17/02; B60T 13/16; B60T 8/36; B60T 11/28

(52) U.S. Cl. 303/11

(57) ABSTRACT

An electrohydraulic brake unit for a hydraulic, single- or multiple-circuit brake system that enables regenerative braking is provided. It comprises a unit body, which comprises electrically actuable fluid control valves and hydraulic connection lines between the fluid control valves, an electronic closed-/open-loop control circuit for supplying trigger signals for the fluid control valves in order to modulate the hydraulic pressure in the brake circuits, and a fluid feed pump. In the unit body a simulator for regenerative braking is at least partially integrated, which comprises at least one cylinder/piston arrangement, with which at least one resetting spring arrangement, in the form of at least one spring element, is associated. This simulator projects at least partially out of the unit body.

### FIELD

An electrohydraulic brake unit for a land vehicle is described here. This may be a brake unit in a hydraulic, single- or multiple-circuit brake system, which comprises electrically actuable fluid control valves, an electronic closed-/open-loop control circuit (ECU) for supplying trigger signals for the fluid control valves in order to modulate the hydraulic pressure in the brake circuits, a fluid feed pump and a unit body, into which hydraulic connection lines between the fluid control valves are incorporated.

### TECHNICAL BACKGROUND

European patent No. 0 720 551 B1-BOSCH discloses a typical form of construction of a conventional unit of this type for slip-regulated brake systems of motor vehicles. This brake unit has a unit body made of light metal having a plurality of stepped receiving bores for the hydraulic part of electromagnetically actuated fluid control valves. This hydraulic part is inserted in each case into a step of the receiving bore and fastened by caulking to the unit body. A pressure-proof valve dome that contains the magnetically effective elements, such as armature and magnet core, of the hydraulic part projects out of the unit body. A separately manufactured electrical part of the fluid control valve that is mounted onto the valve dome has an electric coil, which surrounds the valve dome, and a magnetic-flux-conducting housing, in which at the side facing the unit body a magnetically soft annular disk for conducting the magnetic flux is accommodated.

### UNDERLYING PROBLEM

Proceeding from this conventional brake unit, an electrohydraulic brake unit in a hydraulic brake system is to be provided, which—not least for saving fuel—is capable of enabling a regenerative braking operation in an efficient and economical manner.

Here, by regenerative braking is meant that the kinetic energy released during the braking operation—instead of being converted into frictional heat—is converted back into electrical (potential) energy. Thus, at least some of the braking energy may be used to charge the vehicle battery. The electrical energy needed in the motor vehicle therefore need no longer be obtained entirely from fuel.

### SOLUTION

As a solution to this problem, a brake unit having the features of claim 1 is proposed. This electrohydraulic brake unit may comprise a unit body having electrohydraulic components, such as electrically actuable fluid control valves, hydraulic connection lines between these fluid control valves or the like, an electronic closed-/open-loop control circuit for supplying trigger signals for the fluid control valves in order to modulate the hydraulic pressure in the brake circuits, and a fluid feed pump. Integrated into the unit body is a simulator for regenerative braking, which projects at least partially out of the unit body.

### ADVANTAGES AND DEVELOPMENTS

For the first time such an electrohydraulic brake unit with a simulator for regenerative braking that is partially integrated into the unit body is provided. This simulator has one simulation unit per brake circuit comprising at least one cylinder/piston arrangement and at least one resetting spring arrangement, which comprises at least one spring element. The cylinder/piston arrangement may in this case have a hollow cylinder forming a chamber as well as a piston displaceable therein. The resetting spring arrangement may be provided inside or outside of the hollow cylinder. Each spring element may be a compression spring or a tension spring and have a progressive spring characteristic. The piston divides the hollow cylinder into two chambers, a pressure chamber and a filling chamber, which are demarcated from one another in a fluid-proof manner, for example by means of a sealing element. Each chamber has at least one in-/outflow channel.

The partial integration of the simulator into the unit body is to be realized by recesses in the unit body, into which recesses at least the hydraulic part of the simulation units, in the form of cylinder/piston arrangements, is introduced and fastened. The spring-mechanical part, in the form of the resetting spring arrangements, may, as already mentioned, be situated (partially) inside the hollow cylinder or be connected from outside to the cylinder/piston arrangement. In the case of the latter, the resetting spring arrangement may project at least partially from the unit body.

In conventional regenerative braking units the brake unit communicates via external lines with separate simulation units, or the simulation units are fully integrated into the unit body. Here, in contrast thereto, in order to solve the underlying problem it is proposed that the simulation units be integrated only partially into the unit body.

Compared to the partial integration of the simulator, in which case the simulation units project from the unit body, the simulation units in the case of full integration are completely embedded in the unit body. For this purpose, the unit body has to be of a larger design and is therefore heavier. The partial integration of the simulator results in a more compact and lighter-weight style of construction for the unit body than in the case of full integration.

Compared to a style of construction, in which the simulator is remote from the unit body, the outlay for pipe connections between the simulator and the unit body is reduced. The partial integration of the simulator in the unit body moreover leads to a higher degree of integration. This results i.a. in simplified installation in the motor vehicle and in a lower susceptibility to faults.

Compared to a style of construction, in which the spring arrangements in the simulation units are wetted by hydraulic fluid, i.e. the spring arrangements are surrounded by the hydraulic fluid, the partial integration of the simulator in the unit body reduces the total volume of hydraulic fluid in the in the brake system. This may also lead to a higher rigidity in the hydraulic system. This in turn may lead to improved closed-loop control properties of the brake system.

The different possible ways of implementing the described brake unit moreover also open up new possibilities of utilizing the available installation space efficiently.

The hollow cylinder of the cylinder/piston arrangement, which may be open or closed in the direction of the base of the recess, may be inserted into the unit body in a fluid-proof manner, for example by means of a sealing element, relative to the inside lateral surface of the recess.

If the spring-mechanical part is situated outside of the hollow cylinder, the piston displaceable inside the cylinder/piston arrangement may be connected at the side remote from the recess in the unit body in a fixed manner to an actuating rod. The actuating rod may extend in a fluid-proof manner, for example by means of a sealing element, through an opening in the opposite face of the hollow cylinder to the base of the recess and may continue at the outside. In this case, the part of the actuating rod that projects out of the cylinder/piston arrangement is connected to a detachable arrangement that connects the resetting spring arrangement to the cylinder/piston arrangement. The resetting spring arrangement may be disposed such that it surrounds the actuating rod. It rests, on the one hand, directly or indirectly, i.e. via an introduced element, against the unit body and/or against the hollow cylinder. This element may comprise an annular collar for holding the resetting spring arrangement in position relative to the actuating rod. On the other hand, it is delimited by the detachable arrangement described below.

The actuating rod at its projecting end is provided with a thread. This arrangement, comprising a screw-on element and a limit plate, may be connected by this thread to the actuating rod. The limit plate has an opening, through which the actuating rod extends. It is pressed by the applied spring force against or onto this screwed-on element. This limit plate may comprise for example an annular collar, which holds the resetting spring arrangement in position relative to the actuating rod.

The piston of the cylinder/piston arrangement may be moved into two end positions. If the resetting spring arrangement is unloaded, i.e. no or no significant spring force is acting upon the piston, then the volume of the pressure chamber is maximal and the volume of the filling chamber is minimal. If the full spring force is acting upon the piston, then the filling chamber volume is maximal and the pressure chamber volume is minimal.

The unit body moreover comprises a system of fluid lines connected to the cylinder/piston arrangement. In the installed state in the recess in the unit body, the in-/outflow channels of the hollow cylinder are aligned with the fluid lines opening out into this recess.

This fluid line system opening out into the recess comprises at least one fluid line with a fluid control valve per chamber of the cylinder/piston arrangement. The fluid control valves may be operated by the electronic control unit. Through the fluid lines hydraulic fluid may flow out of the chamber and into the chamber.

Each fluid line or each of the in-/outflow channels of the hollow cylinder may comprise at least one throttle device. The effect achievable with the aid of the throttle device in the fluid line opening out into the pressure chamber is that upon a piston movement in the direction of the pressure chamber the hydraulic fluid may be pressed out of the pressure chamber under fluidic resistance. The throttle device may also be adjustable, for example electromechanically or electromagnetically, in order to set the resistance counteracting the piston movement. Upon a movement of the piston in the direction of a volume reduction of the pressure chamber, the throttle device in the fluid line opening out into the pressure chamber may come into effect and hence damp the piston movement. The throttle device may come into effect likewise upon a piston movement in the direction of a volume enlargement of the pressure chamber under the action of the resetting spring arrangement and hence damp a return flow of hydraulic fluid into the pressure chamber. If the latter is not desired, the fluid line may comprise a bypass channel, which bypasses the fluid line with throttle device (=throttle channel). For example, in this case it may be provided that the bypass channel has a non-return valve that allows hydraulic fluid to pass substantially unimpeded into the pressure chamber and prevents hydraulic fluid from leaving the pressure chamber. In this solution, the non-return valve opens only when the piston under the action of the resetting spring arrangement moves in the direction of the filling chamber. Because of the substantially unimpeded inflow of hydraulic fluid, the piston therefore moves under the action of the spring force relatively rapidly back into the position, in which the resetting spring arrangement is unloaded. The movement characteristic upon a movement of the piston in the direction of a volume reduction of the pressure chamber is however not influenced by the bypass channel with non-return valve because the non-return valve, given such an actuation, closes. Ultimately, by virtue of a parallel connection of the throttle channel and the bypass channel with the non-return valve a hysteresis is superimposed on the movement characteristic of the piston.

The part of the simulator that projects from the unit body may be covered by a single- or multiple-piece housing. This offers protection from environmental influences, with the result that wear, for example as a result of corrosion, may be reduced.

The individual simulation units of the simulator that is partially integrated in the unit body may take the form of preassembled assembly groups, which may be handled individually and are to be inserted into the correspondingly configured recesses in the unit body. Such an assembly group comprises a hollow cylinder, which comprises in accordance with the fluid line system in the unit body one or more out-/inflow channels as well as a piston displaceable in the hollow cylinder. This piston divides the hollow cylinder into two chambers that are separated from one another in a fluid-proof manner, for example by means of a sealing element. In the case of a resetting spring arrangement situated outside of the hollow cylinder, the piston has an actuating rod, which is connected to the piston in a fixed manner and extends in a fluid-proof manner, for example by means of a sealing element, through an opening in the hollow cylinder. If, on the other hand, the resetting spring arrangement is situated in the hollow cylinder, the actuating rod is disposed in a chamber.

Further features, properties, advantages and possible modifications become clear to a person skilled in the art from the following description, in which reference is made to the accompanying drawings.

### BRIEF DESCRIPTION OF THE FIGURES

FIG. 1 shows a diagrammatic representation of a brake system having such an electrohydraulic brake unit.

FIG. 2a shows four diagrammatic views of a first embodiment of the described electrohydraulic brake unit. FIGS. 2b, c, d show three further embodiments of this electrohydraulic brake unit in, in each case, two diagrammatic views.

FIG. 3 shows a diagrammatic cross-sectional view of a simulation unit partially integrated into a recess in the unit body.

### DETAILED DESCRIPTION OF A POSSIBLE EMBODIMENT

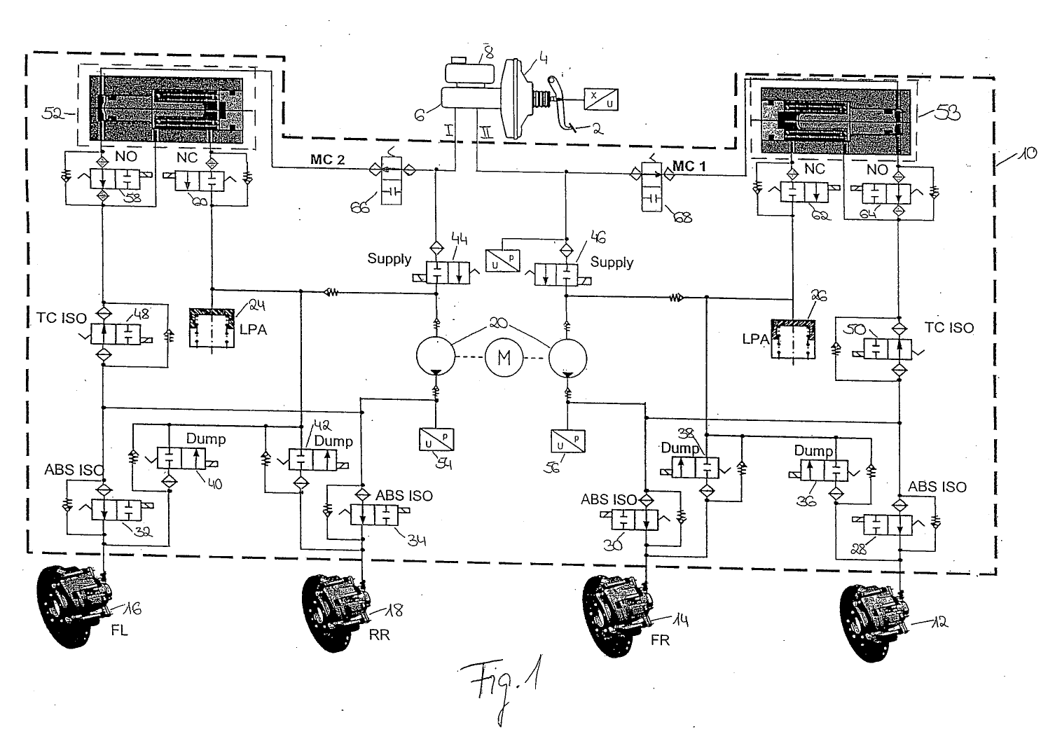

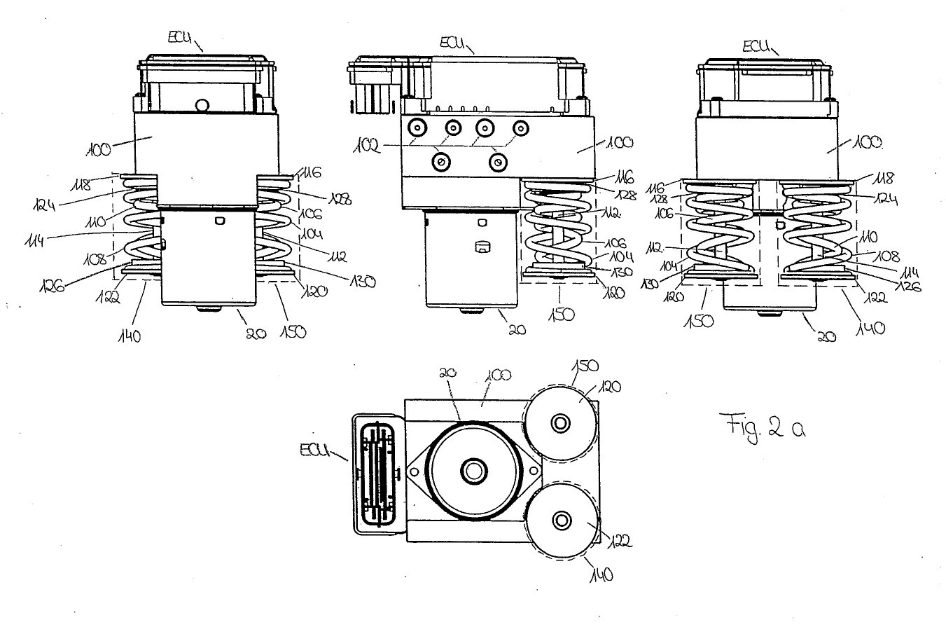

FIG. 1 shows a diagrammatic representation of a hydraulic system.

A brake pedal 2 to be actuated by a driver actuates an input element of a pneumatic brake booster 4, the output element of which acts upon a push rod of a master cylinder 6. The master cylinder 6 has a first and a second cylinder chamber, both of which communicate with a hydraulic reservoir 8. The two cylinder chambers are separated from one another by an intermediate piston and each supply one brake circuit I, II having an electrohydraulic brake unit 10.

Given an diagonal braking force distribution, the two brake circuits I, II comprise, on the one hand, the brake cylinder 12 of the left rear wheel and the brake cylinder 14 of the right front wheel and, on the other hand, the brake cylinder 16 of the left front wheel and the brake cylinder 18 of the right rear wheel. Next to the wheel brake cylinders 12, 14, 16, 18 the associated brake disks are represented.

In the electrohydraulic brake unit 10 a two-circuit fluid feed pump 20, low-pressure storage chambers 24, 26, fluid control valves 28, 30, 32, 34, 36, 38, 40, 42, 44, 46, 58, 60, 62, 64, 66, 68 and high-pressure fluid control valves 48, 50 are provided. The electrohydraulic brake unit 10 additionally comprises a simulator for regenerative braking 52, 53. The electrohydraulic brake unit 10 is so designed that a wheel-specific control based on signals from wheel speed sensors and pressure sensors 54, 56 is achievable for example by means of individual control of the fluid control valves 28, 30, 32, 34, 36, 38, 40, 42; a circuit-specific control is achievable for example by means of the simulator for regenerative braking 52, 53 and control of the fluid control valves 44, 46, 58, 60, 62, 64, the high-pressure fluid control valves 48, 50 or the two-circuit fluid feed pump 20. The trigger signals required for this purpose are supplied by the ECU.

During the regenerative braking operation the fluid control valves 28, 30, 32, 34, 60, 62, 66, 68 are open and the fluid control valves 36, 38, 40, 42, 44, 46, 48, 50, 58, 64 are closed. Through the open fluid control valves 66, 68 hydraulic fluid passes into the filling chambers of the simulator 52, 53. In accordance with the volume increase in the filling chamber hydraulic fluid is displaced from the pressure chamber. This hydraulic fluid passes through the open fluid control valves 60, 62 into the low-pressure storage chambers 24, 26. Thus, for a braking operation, in which the braking requirement exceeds the braking torque that may be taken up by the electrical machines of the vehicle, hydraulic fluid is immediately present at the fluid feed pump 20 so that the friction brakes at the wheels of the vehicle may be loaded with pressure.

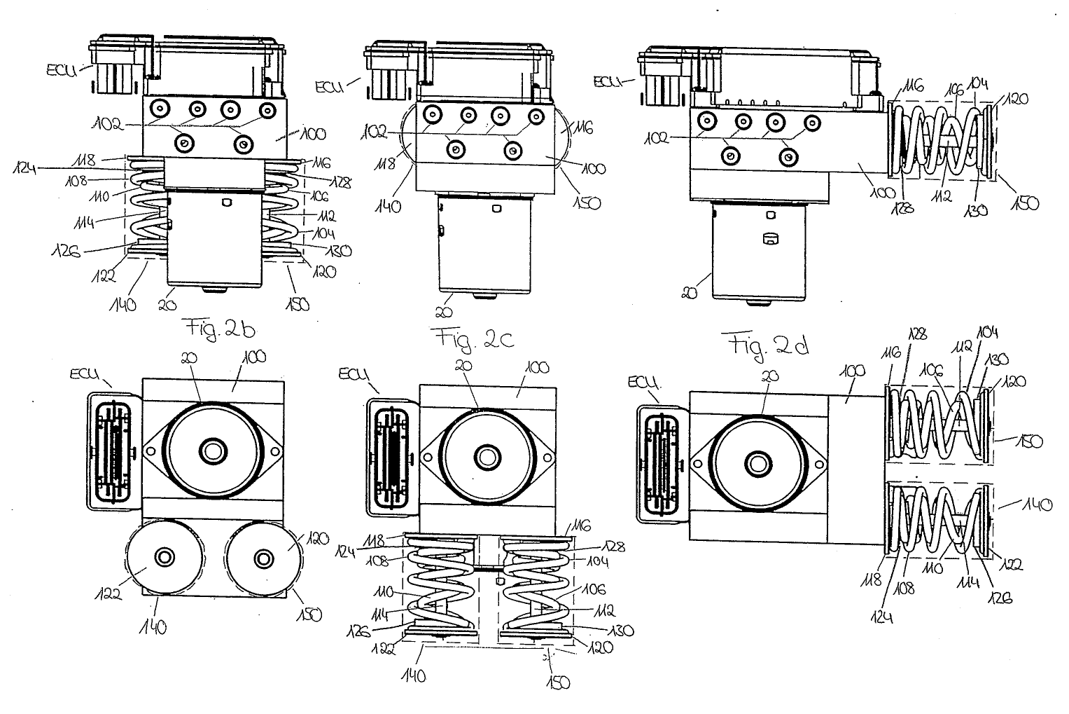

In FIGS. 2a, b, c, d the structural layout of four embodiments of an electrohydraulic brake unit 10 is represented.

It is clear that the electrohydraulic brake unit 10 of FIG. 2a, like the embodiments of FIGS. 2b, c, d, is of a compact construction. It is designed for a hydraulic, two-circuit brake system of a land vehicle and comprises a unit body 100 having the components that are represented in FIG. 1 but not further represented in FIGS. 2a, b, c, d.

Furthermore, the simulator for regenerative braking 52, 53 of FIG. 1 that is partially integrated into the unit body 100 is represented by two simulation units. Both simulation units comprise cylinder/piston arrangements, which here are fully introduced into the unit body 100 and are connected to outwardly visible resetting spring arrangements 140, 150 that project out of the unit body 100. One of these simulation units is described in detail with reference to FIG. 4.

The resetting spring arrangements 140, 150 of these simulation units comprise in each case two spring elements 104, 106; 108, 110, which surround one another. The resetting spring arrangements 140, 150 are disposed in each case so as to surround actuating rods 112, 114. These actuating rods 112, 114 are connected to the cylinder/piston arrangements. The spring elements 104, 106; 108, 110 rest against the unit body 100 via an annular element 116, 118, the annular collar 124, 128 of which holds the spring elements 104, 106; 108, 110 in position relative to the actuating rod 112, 114. They rest against a further annular element 120, 122, which is connected to the end of the actuating rod 112, 114 projecting out of the unit body 100. This element 120, 122 likewise comprises an annular collar 126, 130, by means of which the spring elements 104, 106; 108, 110 are held in position relative to the actuating rod 112, 114.

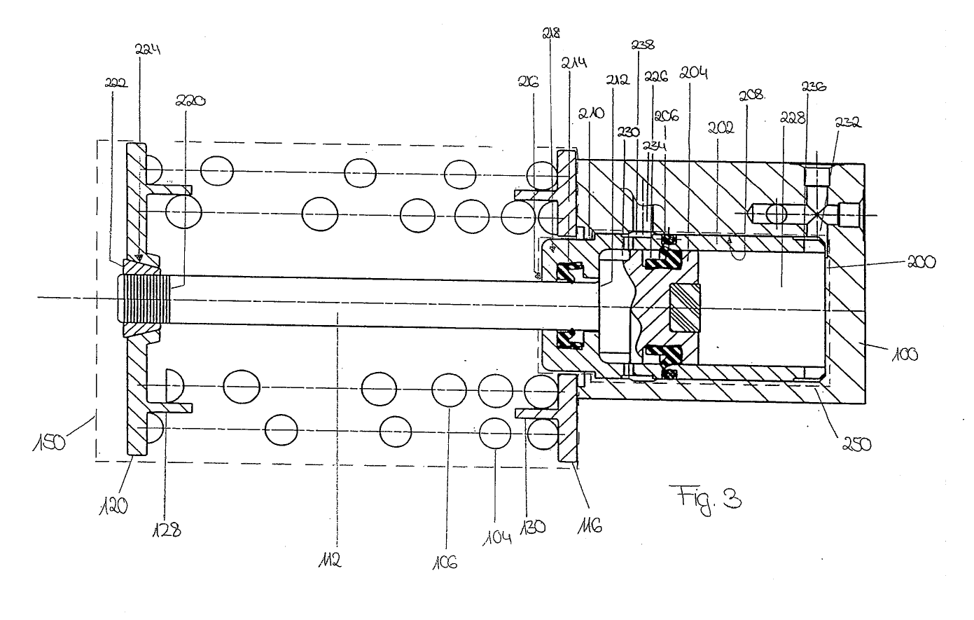

FIG. 4 shows a diagrammatic cross-sectional view of one of the two simulation units represented in FIGS. 2 and 3. One of the two simulation units is described in detail below.

The represented simulation unit 150, 250 is partially integrated into a recess 200 in the unit body 100 and comprises a cylinder/piston arrangement 250 and a resetting spring arrangement 150 connected thereto. This resetting spring arrangement 150 is disposed outside of the cylinder/piston arrangement 250 and projects out of the unit body 100.

The cylinder/piston arrangement 250 comprises a hollow cylinder 202, a piston 204 displaceable therein, and an actuating rod 112 connected in a fixed manner to this piston 204. The hollow cylinder 202 here is open in the direction of the base of the recess 200. The cylinder/piston arrangement 250 is introduced into a recess 200 in the unit body 100. It terminates in a fluid-proof manner, by means of an annular sealing element 206, with the inside lateral surface 208 of the recess 200. By caulking the edge 210 of this recess 200 in the unit body 100 the introduced cylinder/piston arrangement 250 is fastened in a captive and fluid-proof manner.

The actuating rod 112 is connected in a fixed manner to the side 212 of the piston 204 remote from the base of the recess 200. It extends in a fluid-proof manner, by means of an annular sealing element 214, through an opening 216 of the hollow cylinder 202 and continues on the outside. This opening 216 is situated in the opposite face 218 to the base of the recess 200.

The resetting spring arrangement 150 here comprises two compression springs 104, 106 that surround one another. It is disposed around the part of the actuating rod 112 that projects out of the cylinder/piston arrangement 250. The resetting spring arrangement 150 rests against the unit body 100 and is detachably connected to the actuating rod 112. In this embodiment it rests, not directly, but indirectly against the unit body 100. For this purpose, an annular element 116 is introduced between the resetting spring arrangement 150 and the unit body 100. The annular element 116 has an annular collar 130, which holds the spring elements 104, 106 in position relative to the actuating rod 112. The part of the actuating rod 112 that projects out of the hollow cylinder 202 is provided at its end with a thread 220, onto which a conical ring 222 is screwed. The spring elements 104, 106 press a, here annular, plate 120 onto the conical ring 222. The resetting spring arrangement 150 is thereby connected to the cylinder/piston arrangement 250. The annular plate 120 has an opening 224 with a conical edge, through which the actuating rod 112 extends. It moreover has an annular collar 128, by means of which the spring elements 104, 106 are held in position relative to the actuating rod 112.

The piston 204 of the cylinder/piston arrangement 250 divides the hollow cylinder 202 into two chambers, the pressure chamber 228 and the filling chamber 230, which are closed off from one another in a fluid-proof manner, by means of an annular sealing element 226.

The simulation unit 150, 250 is connected to a system of fluid lines 232, 234 incorporated into the unit body 100. A fluid line 232, 234 with fluid control valve opens out into each chamber 228, 230. The fluid control valves are not represented in FIG. 4. They may be controlled by the ECU and hydraulic fluid may flow out of the chambers 228, 230 and into the chambers 228, 230 through the fluid lines 232, 234. For this purpose, for each chamber 228, 230 the hollow cylinder 202 has an in-/outflow channel 236, 238, which in the installed state in the unit body 100 coincides with the fluid lines 232, 234 that open out into the recess 200. These in-/outflow channels 236, 238 are realized in the form of annular recesses in the outer wall of the hollow cylinder that have a plurality of openings into the chambers 228, 230.

If during the regenerative braking operation the driver actuates the brake pedal, the fluid control valve in the fluid line 234 opening out into the filling chamber 230 is moved into its open position and the filling chamber 230 fills. This fluid control valve is not represented in FIG. 4; it corresponds to one of the fluid control valves 66, 68 of FIG. 1. The piston 204 as a result of the rising volume in the filling chamber 230 is moved in the direction of a reduction of the volume of the pressure chamber 228. The compression springs 104, 106 of the resetting spring arrangement 150 are in this case compressed.

If the fluid control valve in the channel 234 opening out into the filling chamber 230 is opened, then the piston 204 in the hollow cylinder 202 moves under the action of the resetting spring arrangement 150 in the direction of a reduction of the volume of the filling chamber 230. The hydraulic fluid that has flowed into the filling chamber 230 is pressed out through the fluid line 234. The pressure chamber 228, which has enlarged as a result of the piston movement in the direction of a volume reduction of the filling chamber 230, is filled once more with hydraulic fluid.

The cylinder/piston arrangement 250 partially integrated in the unit body 100 takes the form of a preassembled assembly group, which may be handled individually and is to be inserted into a recess 200 in the unit body 100. The hollow cylinder 202 of the cylinder/piston arrangement 250 has the piston 204 displaceable therein. The piston 204 is connected in a fixed manner to the actuating rod 112. This actuating rod 112 extends in a fluid-proof manner, by means of the annular sealing element 214, through the opening 216 in the hollow cylinder 202. The piston 204 divides the hollow cylinder 202 into two chambers 228, 230, which are separated from one another in a fluid-proof manner, by means of the annular sealing element 226. The hollow cylinder 202 further comprises one in-/outflow channel 236, 238 per chamber 228, 230. These in-/outflow channels 236, 238 in the installed state in the unit body 100 coincide with the fluid lines 232, 234 that open out into the recess 200.

It is self-evident that the concept explained with the aid of FIGS. 1-4 and the described components represented in FIGS. 1-4 may also be configured and controlled in a different manner to that shown in connection with the configurations of FIGS. 2 and 3. The previous description of the embodiments is for illustrative purposes only and not for the purpose of limitation. In the case of the described brake unit, various changes and modifications are possible without departing from the scope of this brake unit.

1. An electrohydraulic brake unit (10), for a hydraulic, single- or multiple-circuit brake system of a land vehicle, having
a unit body (100) comprising electrohydraulic components, such as electrically actuable fluid control valves (28, 30, 32, 34, 36, 38, 40, 42, 44, 46, 48, 50, 58, 60, 62, 64, 66, 68),
a fluid feed pump (20) with pump drive motor or the like and
an electronic closed-/open-loop control circuit (ECU) for supplying trigger signals for the electrohydraulic components in order to modulate the hydraulic brake circuit pressure,
characterized in that a simulator for regenerative braking (52, 53) is at least partially integrated in the unit body.

2. Electrohydraulic brake unit (10) according to claim 1, characterized in that the simulator (52, 53) comprises at least one simulation unit (150, 250), which comprises a cylinder/piston arrangement (250) and a resetting spring arrangement (150), wherein each simulation unit (52, 53) is disposed at least partially in a recess (200) in the unit body (100).

3. Electrohydraulic brake unit (10) according to claim 2, characterized in that the cylinder/piston arrangement (250) comprises:
a hollow cylinder (202),
a piston (204), which is displaceable in the hollow cylinder (202) and divides the hollow cylinder into two chambers (228, 230), and
at least one in-/outflow channel (236, 238) per chamber (228, 230).

4. Simulation unit (150, 250) according to claim 2 or 3, characterized in that the resetting spring arrangement (150) comprises at least one spring element (104, 106).

5. Simulation unit (150, 250) according to claim 2, 3 or 4, characterized in that the resetting spring arrangement (150) is disposed inside the hollow cylinder (202).

6. Simulation unit (150, 250) according to one of claims 2-4, characterized in that the resetting spring arrangement (150) is disposed outside of the hollow cylinder (202).

7. Simulation unit (150, 250) according to claim 3, characterized in that the piston (204) is connected to an actuating rod (112), which extends in a fluid-proof manner through an opening (216) in the hollow cylinder (202) and continues outside of the hollow cylinder (202).

8. Simulation unit (150, 250) according to claim 7, characterized in that the part of the actuating rod (112) that projects out of the hollow cylinder (202) is provided with a detachable arrangement (120, 122) for connecting the resetting spring arrangement (150) by the actuating rod (112) to the cylinder/piston arrangement (250).

9. Simulation unit (150, 250) according to claim 8, characterized in that the detachable arrangement (120, 122) comprises
a threaded element (222) and
a limit plate (120), which has an opening (224), through which the actuating rod (112) extends.

10. Simulation unit (150, 250) according to claims 8 and 9, characterized in that the projecting end of the actuating rod (112) is provided with a thread (220), by means of which the detachable arrangement (120, 222) is connected to the actuating rod (112).

11. Electrohydraulic brake unit (10) according to claim 1, characterized in that the unit body (100) has fluid lines that open out into the recess (200).

12. Electrohydraulic brake unit (10) according to claims 3 and 11, characterized in that the in-/outflow channels (236, 238) in the hollow cylinder (202), in the assembled state in the unit body (100), coincide with fluid lines (232, 234) that open out into the recess (200).

13. Fluid lines (232, 234) according to claim 12, characterized in that each fluid line (232, 234) opening out into the recess comprises at least one throttle device, which is, in particular electromechanically or electromagnetically, adjustable.

14. Fluid lines (232, 234) according to claim 13, characterized in that each fluid line (232, 234) comprises a bypass channel that bypasses said fluid line (232, 234) with throttle device.

15. Fluid lines (232, 234) according to claim 14, characterized in that the bypass channel comprises a non-return valve that allows hydraulic fluid to pass substantially unimpeded into the pressure chamber (228) and prevents hydraulic fluid from leaving.

16. Electrohydraulic brake unit (10) according to the preceding claims, characterized in that the simulator (52, 53) integrated at least partially into the unit body (100) is covered by a single- or multiple-piece housing.

17. Assembly group of a simulation unit (150, 250) having
a cylinder/piston arrangement (250) comprising a hollow cylinder (202) and a piston (204) displaceable therein, wherein the piston (204) divides the hollow cylinder (202) into two chambers (228, 230) demarcated in a fluid-proof manner from to one another and the hollow cylinder (202) has at least one in-/outflow channel (236, 238) per chamber (228, 230), which channels in the assembled state in the unit body (100) coincide with the fluid lines (232, 234) that open out into the recess (200), and
a resetting spring arrangement (150), which is connected to the cylinder/piston arrangement (250) and comprises at least one spring element (104, 106).
